(19) United States
(12) Patent Application Publication
(10) Pub. No.: US 2004/0154454 A1
(43) Pub. Date: Aug. 12, 2004

(54) Band saw replacing device for band sawing machine

(75) Inventor: Lien-Chu Lee, Taichung Hsien (TW)

Correspondence Address: BROWDY AND NEIMARK, P.L.L.C., 624 NINTH STREET, NW, SUITE 300, WASHINGTON, DC, 20001-5303, US

(73) Assignee: OAV Equipment & Tools, Inc., Taichung Hsien (TW)

(21) Appl. No.: 10/359,144

(22) Filed: Feb. 6, 2003

(51) Int. Cl. B27B 13/00

(52) U.S. Cl. 83/788

(57) ABSTRACT

A band saw replacing device includes a slide seat mounted on a top seat of a machine stand of a band sawing machine, an adjustment rod connected with the slide seat, a pivoting member, and a wrenching member. The pivoting member is pivotally connected to the top seat of the machine stand at an end thereof and is connected with the adjustment rod. The wrenching member is pivotally mounted on the top seat and has an arched engaging portion extending outwards therefrom for supporting the other end of the pivoting member. Accordingly, it's as easy as pushing the wrenching member to facilitate lowering the adjustment rod and to further shorten a distance between a driving wheel mounted on the slide seat and a driven wheel mounted on the machine stand, thereby replacing a band saw fitted on the driving wheel and the driven wheel rapidly and efficiently.

### BACKGROUND OF THE INVENTION

1. Field of the Invention

The present invention relates generally to band sawing machines, and more particularly to an improved band saw replacing device, which facilitates the replacement of band saws of a band sawing machine.

2. Description of the Related Art

A regular band sawing machine, as illustrated in FIG. 1, is composed of a machine stand 1, two rollers, a band saw 3, a guiding device 4, and a workbench 5. The machine stand 1 substantially includes a bottom seat, a side pillar, and a top seat. A drive motor (not shown) is mounted on the bottom seat of the machine stand 1 for a driving source. The two rollers are respectively a driving wheel 2A mounted on the bottom seat of the machine stand 1 and a driven wheel 2B mounted on the top seat of the machine stand 1. The band saw 3 runs on the driving wheel 2A and the driven wheel 2B. Accordingly, the driving wheel 2A is driven by the drive motor (not shown) to rotate by the drive motor (not shown) and then the driven wheel 2B will be therewith synchronically driven to rotate by the driving wheel 2A via the band saw 3. Besides, the band saw 3 is longitudinally put through the workbench 5 at a side thereof for sawing a workpiece and is controlled to move in predetermined positions and directions by the guiding device 4.

This is to be noted that the band saw 3 is expendable and will be frequently worn-out and replaced during the band sawing machine's working. While the band saw 3 is worn-out, the band saw 3 will be replaced by that shorten a predetermined distance between the driving wheel 2A and the driven wheel 2B to loosen the band saw 3 and after a new band saw is installed, recover the predetermined distance between the two rollers to tighten the new band saw for running on the two rollers. A conventional band saw replacing device for replacing the band saw of the band sawing machine is composed of a slide seat 6, a threaded rod 7, and a wrenching member 8. The slide seat 6 is slidably mounted on the top seat of the machine stand 1 for the driven wheel 2B rotatably connected therewith and is free to traverse. The threaded rod 7 is longitudinally inserted through the slide seat 6 and contacts against a housing of the machine stand 1 at a bottom end thereof The wrenching member 8 is mounted on a top end of the threaded rod 7 for controlling the slide seat 6 to move upwards or downwards so as to further adjust the distance between the two rollers to remove the worn-out band saw 3.

However, while removing the worn-out band saw 3, shortening a great amount of distance between the two rollers is required for facilitating removing the band saw 3, and a screw pitch of the threaded rod 7 is relatively small. Accordingly, it takes much time to complete the removing of the band saw 3 so as to be inefficient.

### SUMMARY OF THE INVENTION

The primary objective of the present invention is to provide an improved band saw replacing device, which facilitates altering a distance between a driving wheel and a driven wheel of a band sawing machine to further rapidly remove and install a band saw so as to enhance working efficiency.

The foregoing objective of the present invention is attained by the band saw replacing device, which is composed of a slide seat, an adjustment rod, a pivoting member, and a wrenching member. The slide seat, which is mounted on a top seat of a machine stand of a band sawing machine and is rotatably mounted with a driven wheel, is free to traverse and drives the driven wheel to slidably move upwards and downwards. The adjustment rod is connected with the slide seat. The pivoting member has an end pivotally connected to a side of the top seat of the machine stand and can drive the adjustment rod to move upwards and downwards. The wrenching member has an end embodied as a pivot portion pivotally mounted on the top seat of the machine stand, the other end having a gripping portion, and an arched engaging portion extending outwards from the pivot portion for supporting a free end of the pivoting member.

Accordingly, while replacing the band saw, it's as easy as pushing the wrenching member to facilitate lowering the adjustment rod and to further shorten the distance between a driving wheel and the driven wheel, thereby replacing the band saw efficiently.

### BRIEF DESCRIPTION OF THE DRAWINGS

FIG. 1 is a schematic view of a conventional band sawing machine;

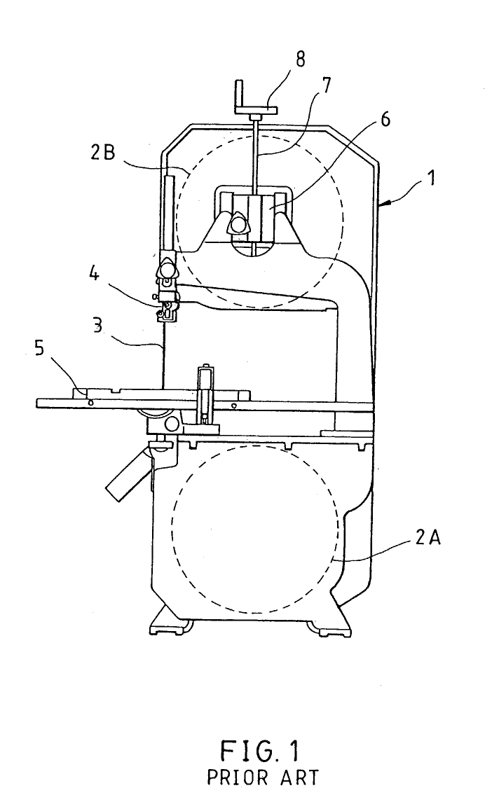

FIG. 2 is a perspective view of a first preferred embodiment of the present invention installed on a band sawing machine;

FIG. 3 is a side view of the first preferred embodiment of the present invention;

FIG. 4 is an exploded view of the first preferred embodiment of the present invention;

FIG. 5 is a schematic view of the first preferred embodiment of the present invention at work; and

FIG. 6 is a side view of a second preferred embodiment of the present invention.

### DETAILED DESCRIPTION OF THE INVENTION

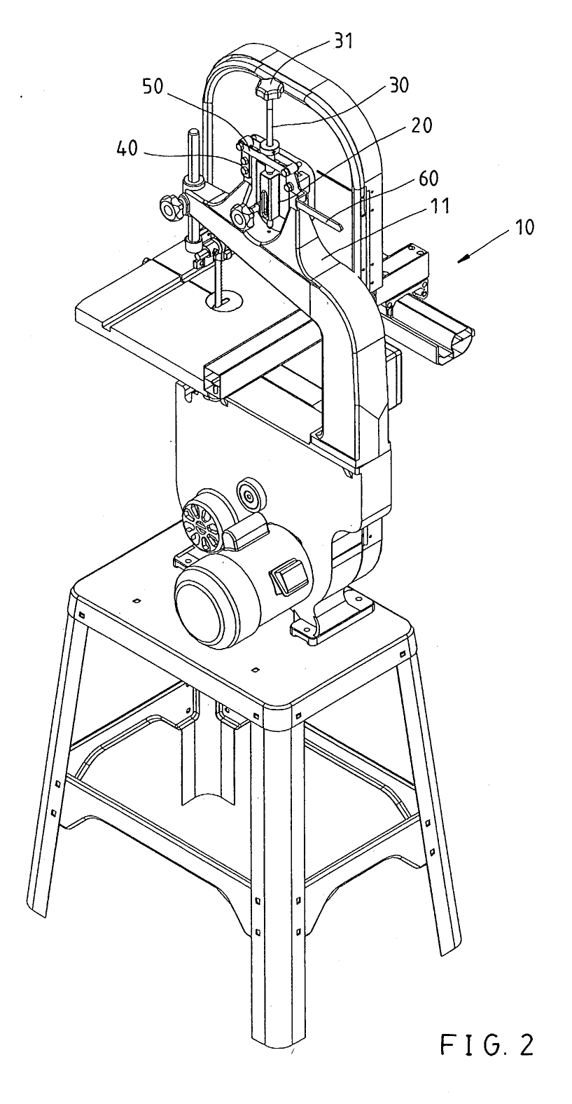

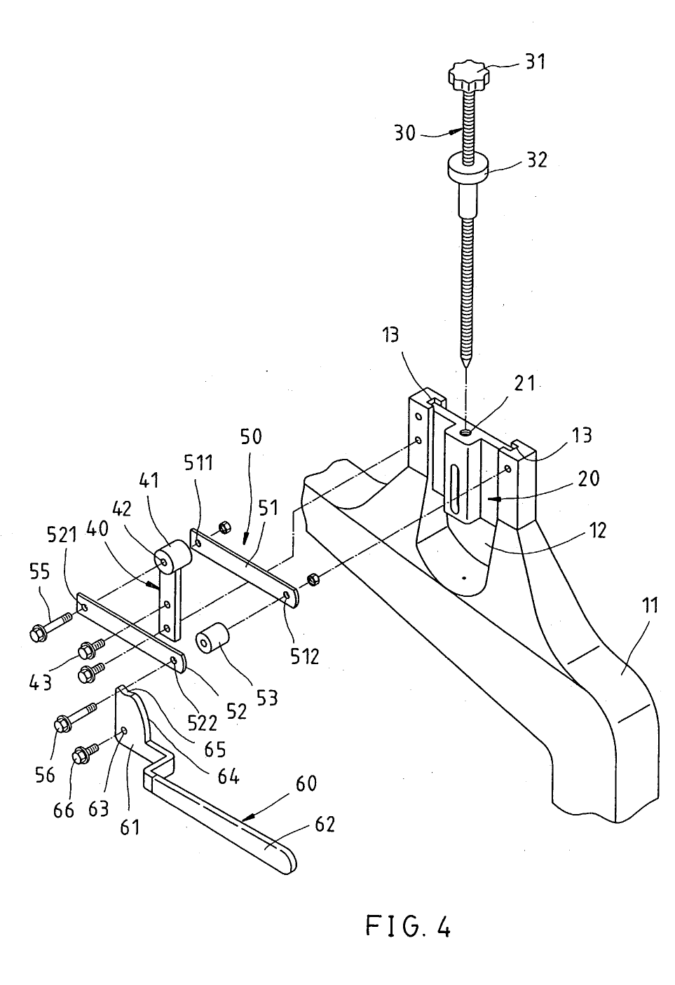

Referring to FIGS. 2-4, a band saw replacing device of the present invention is mounted on a top seat 11 of a machine stand of a band sawing machine 10. The top seat 11 of the machine stand has a U-shaped recessed portion 12 and two slide slots 13 at two sides of the recessed portion 12. The band saw replacing device is composed of a slide seat 20, an adjustment rod 30, a fixture 40, a pivoting member 50, and a wrenching member 60.

The slide seat 20 includes a threaded hole 21 longitudinally running therethrough and is slidably mounted on the slide slots 13 at two sides thereof such that the slide seat 20 is free to traverse. A driven wheel (not shown) is rotatably mounted on a side of the slide seat 20 for a band saw rotatably mounted thereon and for synchronically driving the band saw to run.

The adjustment rod 30 has a body portion provided with a screw thread for longitudinally threadedly running through the threaded hole 21 of the slide seat 20, a wheeling member 31 mounted on a top end thereof, and a cylindrical retaining block 32 threadedly mounted on the body portion thereof and having a larger diameter than that of the threaded hole 21 of the slide seat 20.

The rod-like fixture 40 has a pivot portion 41 at a top end thereof and a through hole 42 positioned at the pivot portion 41. The fixture 40 is fixedly mounted to a side of the top seat 11 of the machine stand by two bolts 43.

The pivoting member 50 includes a sleeve 53 and two lateral rods 51, 52, which respectively have two through holes 511, 512 and 521, 522 at two ends thereof A bolt 55 is inserted through the through holes 521, 42, 511 such that the fixture 40 is pivotally connected between two ends of the two lateral rods 51 and 52 of the pivoting member 50. Another bolt 56 is inserted through the through holes 522 and 512 and sleeve 53 such that the sleeve 53 is pivotally connected between the other two ends of the two lateral rods 51 and 52 of the pivoting member 50. In addition, the adjustment rod 30 is put downwards to run through between the two lateral rods 51 and 52 such that a bottom side of the retaining block 32 is put contacting against a top side of the two lateral rods 51 and 52.

The wrenching member 60 has a plate-like pivot portion 61 at an end thereof and a cranked rod-like gripping portion 62 at the other end thereof The pivot potion 61 is provided with a through hole 63 through which a bolt 66 is inserted so as to be pivotally mounted on a side of the top seat 11 of the machine stand opposite to the fixture 40. It is to be noted that the pivot portion 61 has an arched engaging portion 64 extending upwards therefrom. A distance between an outer fringe of the engaging portion 64 and a center of the through hole 63 is decreasingly reduced from a top side to a bottom side of the engaging portion 64. Additionally, the engaging portion 64 is recessed with an arched positioning recess 65 at a top end thereof for embedding and positioning the sleeve 53 of the pivoting member 50.

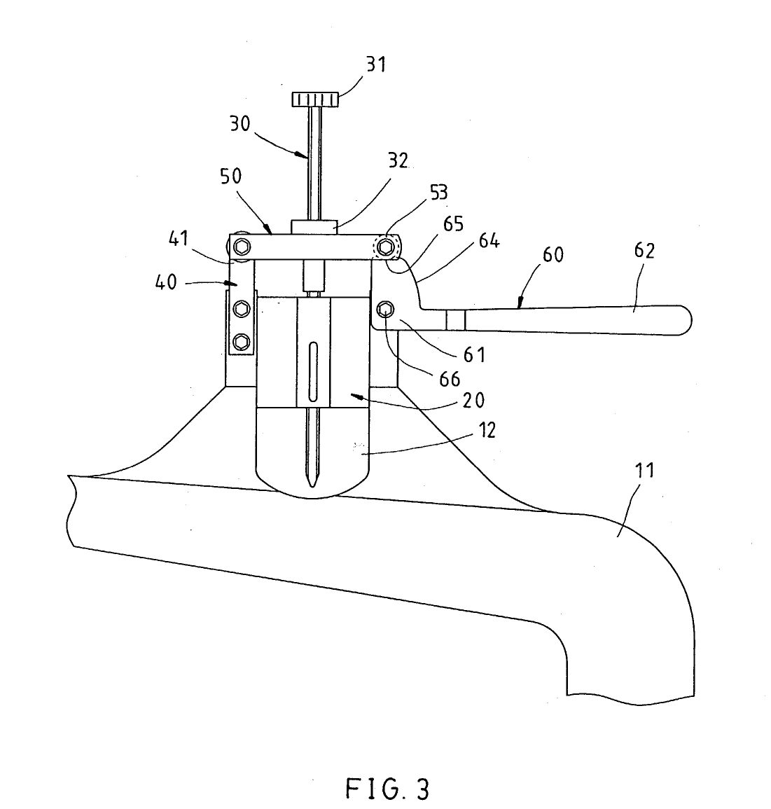

As shown in FIG. 3, while the band sawing machine 10 is normally operated, the wrenching member 60 is positioned horizontally, the sleeve 53 of the pivoting member 50 is embedded and positioned to the positioning recess 65 of the wrenching member 60, and the retaining block 32 of the adjustment rod 30 is put lying against the pivoting member 50. Accordingly, the adjustment rod 30 and the slide seat 20 are located in the highest first position, that is, the driven wheel (not shown) and a driving wheel (not shown) are spaced apart at the greatest distance, thereby tightening the band saw (not shown). Moreover, a position of the adjustment rod 30 and the slide seat 20 can be changed by adjusting a position of the retaining block 32 located on the adjustment rod 30 so as to further adjust the tightness of the band saw running on the driving and driven wheels (not shown).

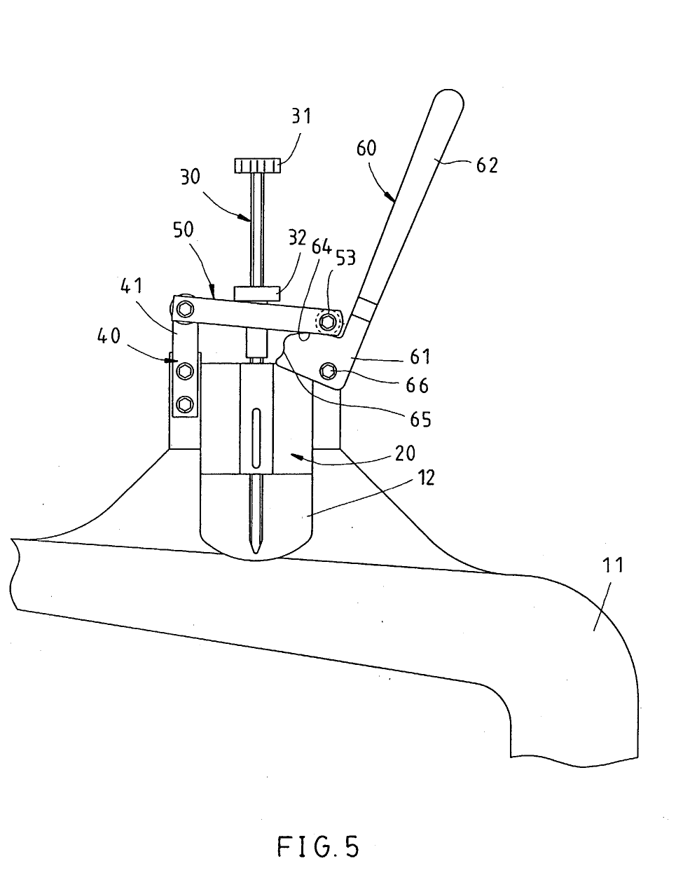

While proceeding to removing the band saw (not shown), the wrenching portion 60 is pushed to pivot counterclockwise about the bolt 66 by holding and pushing the gripping portion 62 thereof At the same time, a vertical distance between the outer fringe of the engaging portion 64 and the center of the through hole 63 is decreasingly reduced. The whole gravity of the driven wheel (not shown), the slide seat 20, and the adjustment rod 30 works on the pivoting member 50 via the retaining block 32, such that the sleeve 53 of the pivoting member 50 moves downwards along the outer fringe of the engaging portion 64 so as to further synchronically lower the position of the adjustment rod 30 and the slide seat 20. While the wrenching member 60 is pivoted counterclockwise at an angle approaching 90°, as is shown in FIG. 5, the adjustment rod 30 is in the lowest second position, that is, the driven wheel (not shown) and the driving wheel (not shown) are spaced apart at the least distance, thereby loosening the band saw (not shown) and further proceeding to replacing the band saw (not shown). Therefore, it is convenient, rapid, and efficient to replace the band saw (not shown).

After the band saw (not shown) is replaced, the wrenching member 60 is pushed clockwise such that the adjustment rod 30 and the slide seat 20 return to the first position from the second position and the band saw is tightened again. In addition, the position of the retaining block 32 located on the adjustment rod 30 can be adjusted to change the tightness of the band saw if necessary.

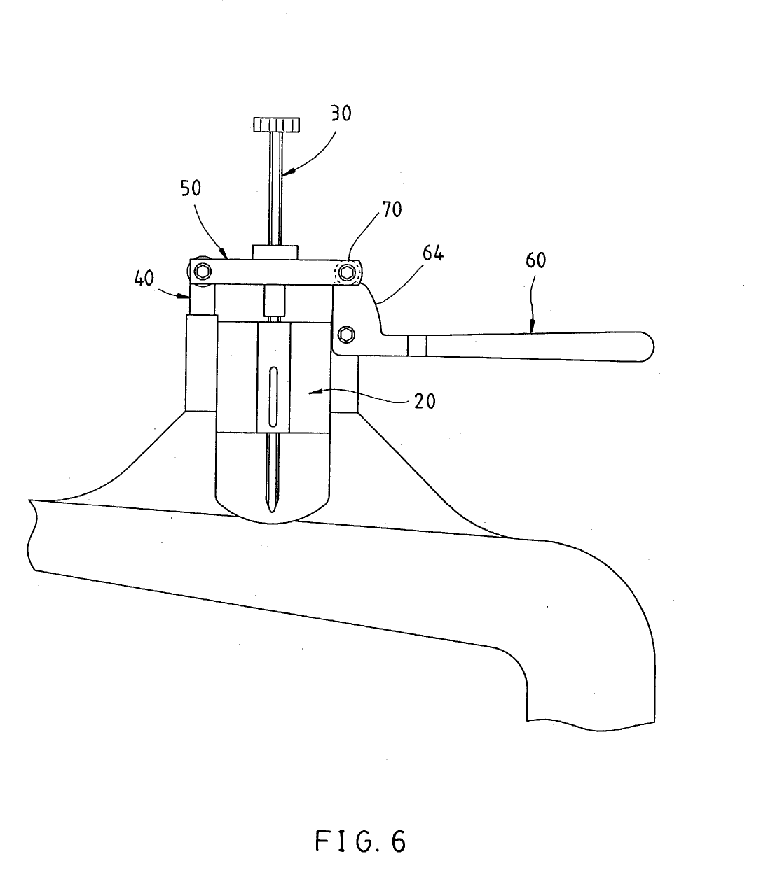

Because the pivoting member 50 is under the whole gravity of the driven wheel (not shown), the slide seat 20, and the adjustment rod 30, while the sleeve 53 of the pivoting member 50 slidably moves along the outer fringe of the arched engaging portion 64 of the wrenching member 60, a great friction will be generated between the sleeve 53 and the outer fringe of the engaging portion 64 so as to difficultly push the wrenching member 60. Accordingly, a bearing 70 instead of the sleeve 53 in a second preferred embodiment of the present invention, as shown in FIG. 6, is installed to reduce the friction and to further facilitate pushing the wrenching member 60. Additionally, the fixture 40 can alternatively extend outwards from the top seat 11 of the machine stand so as to simplify the cost in production and assembly.

In conclusion, the present invention is characterized in that the engaging portion of the wrenching member is arched at the outer fringe thereof and the slide seat and the driven wheel move counterclockwise by the gravity of the slide seat and the driven wheel while the wrenching member is pushed counterclockwise such that it's rapid and convenient to replace the band saw. In addition, the tightness of the band saw running on the driving and driven wheels can be changed by the retaining block.

What is claimed is:

1. A band saw replacing device mounted on a top seat of a machine stand of a band sawing machine, said top seat of said machine stand having a U-shaped recessed portion and two slide slots positioned at two sides of said recessed portion, said band saw replacing device comprising:
a slide seat for rotatably mounting a driven wheel thereon at a side thereof, said slide seat being positioned within said recessed portion and slidably mounted to said two slide slots at two sides thereof so as to slidably traverse;
an adjustment rod connected with said slide seat;
a pivoting member having an end pivotally mounted to a side of the top seat of the machine stand for driving said adjustment rod to slidably traverse; and
a wrenching member having a pivot portion located at an end thereof and pivotally mounted on the top seat of the machine stand corresponding to said pivoting member, a gripping portion extending from the other end thereof, and an arched engaging portion extending outwards from a side thereof in proximity of said pivoting member for supporting a free end of said pivoting member, wherein a distance between an outer fringe of said engaging portion and a center of said pivot portion of the wrenching member ranges.

2. The band saw replacing device as defined in claim 1, wherein said slide seat is longitudinally provided with a threaded hole, and said adjustment rod includes a body portion having a thread inserted in said threaded hole of said slide seat.

3. The band saw replacing device as defined in claim 1, wherein said adjustment rod further includes a retaining block fitted thereto, said retaining block contacting against said pivoting member.

4. The band saw replacing device as defined in claim 1, wherein the distance between the outer fringe of said engaging portion and the center of said pivot portion of the wrenching member is gradually reduced from a top side to a bottom side of the engaging portion.

5. The band saw replacing device as defined in claim 1, wherein said arched engaging portion is further recessed with an arched positioning recess at a top end thereof.

6. The band saw replacing device as defined in claim 1, wherein said pivoting member includes two lateral rods, said two lateral rods being pivotally connected with said top seat of said machine stand at an end thereof and pivotally connected with two sides of a sleeve at the other end thereof.

7. The band saw replacing device as defined in claim 6, wherein said adjustment rod is inserted downwards through between said two lateral rods.

8. The band saw replacing device as defined in claim 1, wherein said pivoting member includes two lateral rods, said two lateral rods being pivotally connected with said top seat of said machine stand at an end thereof and pivotally connected with two sides of a bearing at the other end thereof.
